(19) United States
(12) Patent Application Publication
(10) Pub. No.: US 2013/0073945 A1
(43) Pub. Date: Mar. 21, 2013

(54) DYNAMIC REORGANIZATION OF PAGE ELEMENTS OF A WEB APPLICATION

(71) Applicants: Nicholas D. Bingell, Raleigh, NC (US); Erich P. Hoppe, Apex, NC (US); Andrew J. Ivory, Wake Forest, NC (US); David M. Stecher, Durham, NC (US)

(72) Inventors: Nicholas D. Bingell, Raleigh, NC (US); Erich P. Hoppe, Apex, NC (US); Andrew J. Ivory, Wake Forest, NC (US); David M. Stecher, Durham, NC (US)

(73) Assignee: International Business Machines Corporation, Armonk, NY (US)

(21) Appl. No.: 13/233,777

(22) Filed: Sep. 15, 2011

(51) Int. Cl. G06F 17/24

(52) U.S. Cl. 715/234

(57) ABSTRACT

Exemplary embodiments disclose dynamic reorganizing page elements of a web application for increased user viewability and access. The example embodiments include in response to a server presenting the web application, monitoring by analytics software a set of accesses from user computers to the page elements to detect trends in usage patterns; visualizing the trends in the usage patterns by dynamically modifying a layout of the page elements based on the trends; and outputting the modified layout of page elements for presentation to the user computers.

### BACKGROUND

Many, if not most, websites comprise one or more web applications, which are an application that is accessed over a network such as the Internet by user computers and displayed via a browser. Web applications use information resources or web documents written in a standard format such as HTML and/or XHTML. Each information resource may include any number of page elements, which are containers of graphical objects, e.g., hyperlinks.

A typical website may include many web applications and many page elements. For, example, a website may have hundreds of hyperlinks scattered on various different web pages. Visitors to a particular website learn how to navigate to the hyperlinks they wish to view. However, when a portion of the website is down or the user visits a new website, it may not be readily apparent to the user which page elements are the most relevant for the user's intentions.

Accordingly, it would be desirable to provide an improved method and system for increasing ease of access to commonly used page elements.

### BRIEF SUMMARY

The exemplary embodiments provide methods and systems for dynamically reorganizing page elements of a web application. Aspects of the exemplary embodiments include in response to a server presenting the web application, monitoring by analytics software a set of accesses from user computers to the page elements to detect trends in usage patterns; visualizing the trends in the usage patterns by dynamically modifying a layout of the page elements based on the trends; and outputting the modified layout of page elements for presentation to the user computers.

According to the method and system disclosed herein, the exemplary embodiments reposition page elements relative to each other so that commonly used page elements are made more obvious and prominent in an information resource such as a web page, thereby enhancing ease-of-access by users. In a further embodiment, a visual characteristic of at least one of the page elements may be modified in addition to modifying the layout.

### BRIEF DESCRIPTION OF SEVERAL VIEWS OF THE DRAWINGS

FIG. 1 is a logical block diagram illustrating an exemplary embodiment for a system that dynamically reorganizes page elements of a web application.

FIG. 2 is a flow diagram illustrating one embodiment of a process for dynamically reorganizing page elements of a web application.

FIGS. 3A and 3B are diagrams illustrating an example web page showing how the exemplary embodiments may be used to increase viewability of page elements therein.

### DETAILED DESCRIPTION

The exemplary embodiment relates to dynamically reorganizing page elements of a web application. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The exemplary embodiments provide methods and systems that increase ease of access to commonly used page elements by dynamically reorganizing page elements of a web application to make the most accessed elements more prominent.

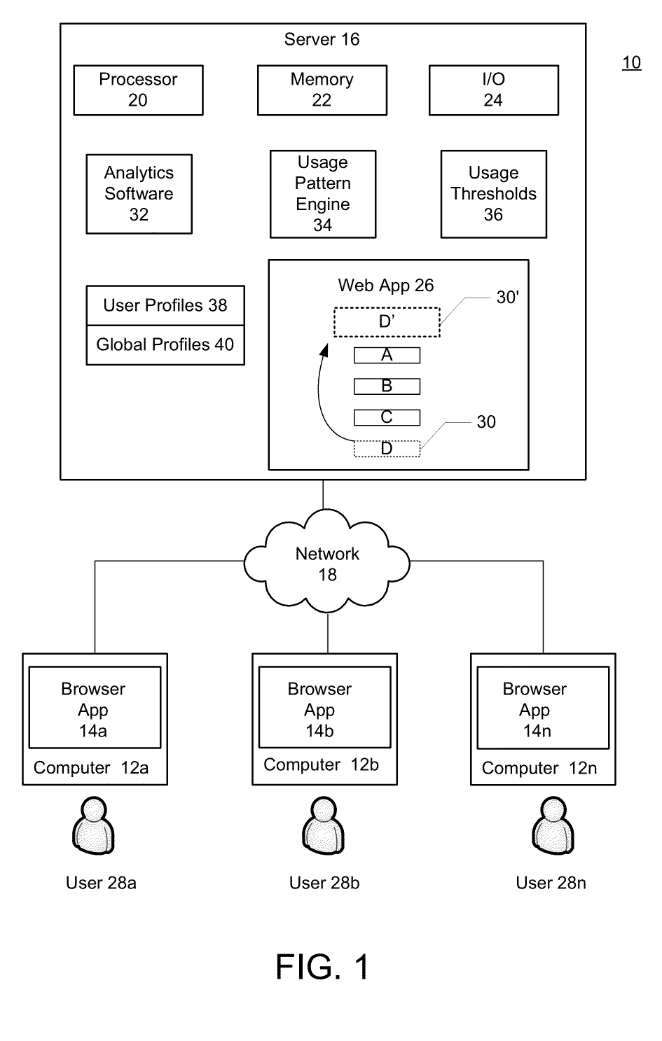

FIG. 1 is a logical block diagram illustrating an exemplary embodiment for a system that dynamically reorganizes page elements of a web application. The system 10 may include one or more computers 12a, 12b, 12n (collectively, computers 12) executing respective browser applications 14a, 14b, 14n (collectively, browser applications 14) and that communicate with a server 16 over network 18. The network 18 may be a public network, such as the Internet, or a private network (such as an intranet), a LAN, a WLAN, or a WMAX, or a combination of thereof. The server 16 may represent a single server or multiple servers, each having at least a processor 20, a memory 22, and an input/output (I/O) 24 coupled together via a system bus (not shown). In one embodiment, the server 16 may comprise a Web server, while in another embodiment, the server 16 may comprise an application server.

The computers 12 may exist in various forms, including a personal computer (e.g., desktop, laptop, or notebook), a mobile phone, a personal digital assistant (PDA), a set-top box, a game system, and the like. Similar to the server 16, the computers 12 may include components of typical computing devices, such as processors, input devices (e.g., keyboard, pointing device, microphone for voice commands, buttons, touch screen, etc.), output devices (e.g., a display device). The server 16 and the computers 12 may further include computer-readable media, e.g., memory and storage devices (e.g., flash memory, hard drive, optical disk drive, magnetic disk drive, and the like) containing computer instructions that implement an embodiment of a dynamically reorganizing user interface of a web application when executed by the processor 20.

The processor 20 may be part of data processing system suitable for storing and/or executing software code including an operating system and various web applications 16. The processor 20 may be coupled directly or indirectly to elements of the memory 22 through a system bus (not shown). The memory elements can include local memory employed during actual execution of the program code, bulk storage, and cache memories which provide temporary storage of at least some program code in order to reduce the number of times code must be retrieved from bulk storage during execution.

The input/output 24 or I/O devices (including but not limited to keyboards, displays, pointing devices, etc.) can be coupled to the system either directly or through intervening I/O controllers. Network adapters (not shown) may also be coupled to the system to enable the data processing system to become coupled to other data processing systems or remote printers or storage devices through intervening private or public networks. Modems, cable modems and Ethernet cards are just a few of the currently available types of network adapters.

In operation, the server responds to different requests from the browser applications 14 executing on the computers 12 and presents, or serves, at least one web application 26 to the browser applications 14 for display to users 28a-28n (collectively referred to as users 28) of the computers 12.

As used herein, the web application 26 is an application that is accessed over a network such as the Internet or an intranet. In another embodiment, the web application may refer to a software application that is hosted in a browser-controlled environment (e.g., a Java applet) or coded in a browser-supported language (such as JavaScript, combined with a browser-rendered markup language like HTML) and reliant on a common web browser to render the application executable. Web applications use information resources or web documents that are written in a standard format such as HTML and/or XHTML, and supported by a variety of web browsers. Each information resource may include any number of page elements 30, where each page element 30 defines a container of one or more graphical objects.

The users 28 of the computers 12 interact with the web application 26, e.g., by clicking the page elements 30 using pointing devices, such as a mouse or stylus. If a user's computer 12 is touch-screen enabled, the user 28 may also interact with web application 26 by touching a display screen of the computer 12 using a stylus or the user's finger.

The server 16 includes a component, referred to as analytics software 32, which is used to monitor a set of accesses from the user computers 12 to the page elements 30 comprising the web application 26 and to detect trends in the usage patterns. The analytics software 32 may be implemented as a standalone application or as a plug-in to the web application 26. One example of a commercially available analytics application is Analytics™ by Webtrends of Portland Oreg.

According to the exemplary embodiment, the server 16 further includes a usage pattern engine 34 that visualizes the detected trends in the usage patterns by dynamically reorganizing a layout of the page elements 30 and optionally modifying a visual characteristic of at least one of the page elements 30.

In one embodiment, the usage pattern engine 34 compares the detected usage patterns to a set of usage thresholds 36. For example, assume in FIG. 1 that the analytics software 32 detects an increase in accesses to a link corresponding to the page element 30. If the usage pattern engine 34 determines that this increase exceeds a predetermined percentage, such as 30%, over the average access rate, then the usage pattern engine may dynamically reflect this change my moving the page element 30 to a new position and by optionally resizing the page element 30 as well. This creates a repositioned page element 30′ that is then more prominently displayed by the web application 26, thereby increasing the ease of access to this commonly used page element.

In one embodiment, each of the users 28 must enable the dynamic page element reorganization feature for the web application 26, e.g., in response to a prompt from the web application 26. Enabling this feature enables the web application 26 to adjust and learn how best to display content based on the user's behavior. In one embodiment, user-configurable preferences may be set to enable a user profile 38 or a global profile 40, where the user profile 38 configures the usage pattern engine 34 to dynamically modify the page elements based on the individual user's usage patterns, and the global profile 40 configures the usage pattern 34 to dynamically modify the page elements based on all user's usage patterns.

Although the server 18 is shown as a single computer, it should be understood that the functions of server 18 may be distributed over more than one server. For example, the analytics software 32 and the usage pattern engine 34 may be implemented as a virtual entity whose functions are distributed over multiple servers. Although the analytics software 32 and the usage pattern engine 34 are shown as separate components, the functionality of each may be combined into a lesser or greater number of modules/components. In addition, although a server 12 is shown hosting the analytics software 32 and the usage pattern engine 34, the analytics software 32 and the usage pattern engine 34 may be run on any type of one more computers that have memory and processor.

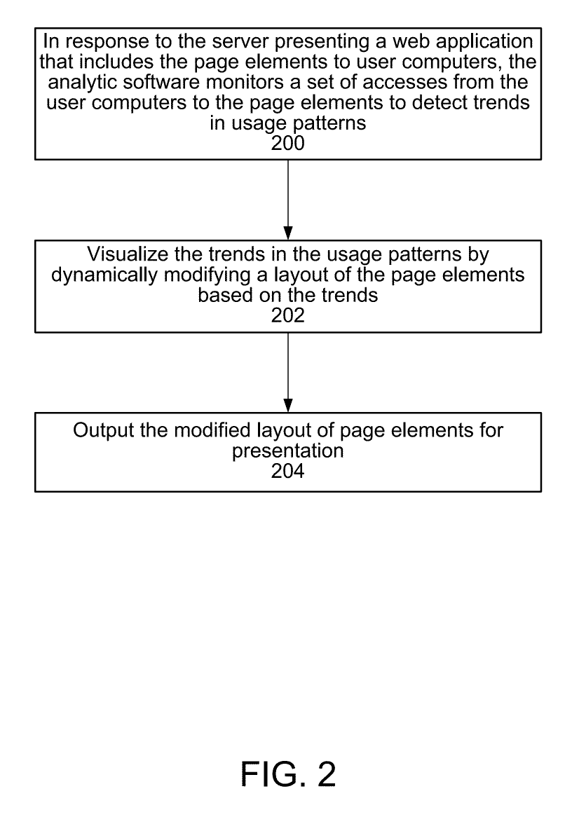

FIG. 2 is a flow diagram illustrating one embodiment of a process for dynamically reorganizing page elements of a web application. In one embodiment, in response to the server 16 presenting a web application 26 that includes the page elements 30, the analytics software monitors a set of accesses from user computers 12 to the page elements 30 to detect trends in usage patterns (block 200).

The analytics software 32 may be used to determine recent trends or long-term usage information in how the page elements 30 of the web application 26 were accessed by users 28. The analytics software 32 may store statistics of a number of hits (e.g., how many times a particular page element is clicked), pages views and unique visitors/users 28 the web application 26 receives overtime, for example, hourly, daily, weekly, monthly, and so on. In one embodiment, the analytics software 32 may be configured to detect trends in usage patterns for at least one of the following: all users 28 of the web application 26, a subset of all the users 28 of the web application 26, an individual user 28 of the web application 26, users 28 of the web application 26 associated with a social network, and a monitored condition.

The usage pattern engine 34 accesses the statistics compiled by the analytics software 32 and visualizes the trends in the usage patterns by dynamically modifying a layout of the page elements 30′ based on the trends, such as frequency of use (block 202). As used herein, modifying the layout of the page elements includes changing a location of at least one of the page elements 30′ relative to other page elements. For example, in an embodiment where the page elements are displayed by the web application 26 in an information resource, modifying a layout of the page elements may include moving a position of at least one of the page elements 30′ towards a top of the information resource as the usage of the at least one page element increases; and moving the position of the at least one of the page elements towards a bottom of the information resource as the usage of the at least one of the page elements decreases.

In another embodiment, the usage pattern engine 34 may be configured to add or remove at least one of the page elements 30 to or from the information resource based on increased use or decreased use, respectively. For example, the usage pattern engine 34 may dynamically add a commonly used link to a home page for easier access by the users.

Accordingly, the usage pattern engine 34 is configured to reposition the page elements relative to each other so that commonly used page elements are made more obvious and prominent in an information resource such as a web page, thereby enhancing ease-of-access by the users 28.

To further enhance the viewability of commonly used page elements, the usage pattern engine 34 may also modify a visual characteristic of at least one of the page elements 30 in addition to or instead of modifying the layout. As used herein, modifying a visual characteristic of at least one of the page elements may comprises changing the color of one of the page elements and/or increasing or decreasing a size of the at least one of the page elements as usage of page the element increases or decreases, respectively.

According to the exemplary embodiments, modifying the layout of the page elements and/or a visual characteristic of the page elements based on frequency of use enhances the viewability of the most commonly used page elements and makes it easier for users to find those page elements in an information resource such as a web page.

As stated above, the usage pattern engine 34 compares statistical information regarding the detected usage patterns to a set of usage thresholds 36. For example, the software 32 may compile not only the number of hits for each page element over time, but also a change percentage of access hits (e.g. a 30% access increase). The usage pattern engine 34 may include heuristics or rules that compare the percentage change for a particular page element to one or more of the usage thresholds 36, and if the percentage change meets the usage thresholds 36, the position and/or visual characteristic of the page element may be adjusted in proportion to the change percentage.

After the usage pattern engine 34 dynamically modifies the layout and/or the visual characteristic of the page elements 30′, the usage pattern engine 34 outputs the modified layout of page elements 30′ for presentation by the server 16 to the user computers 28 (block 204).

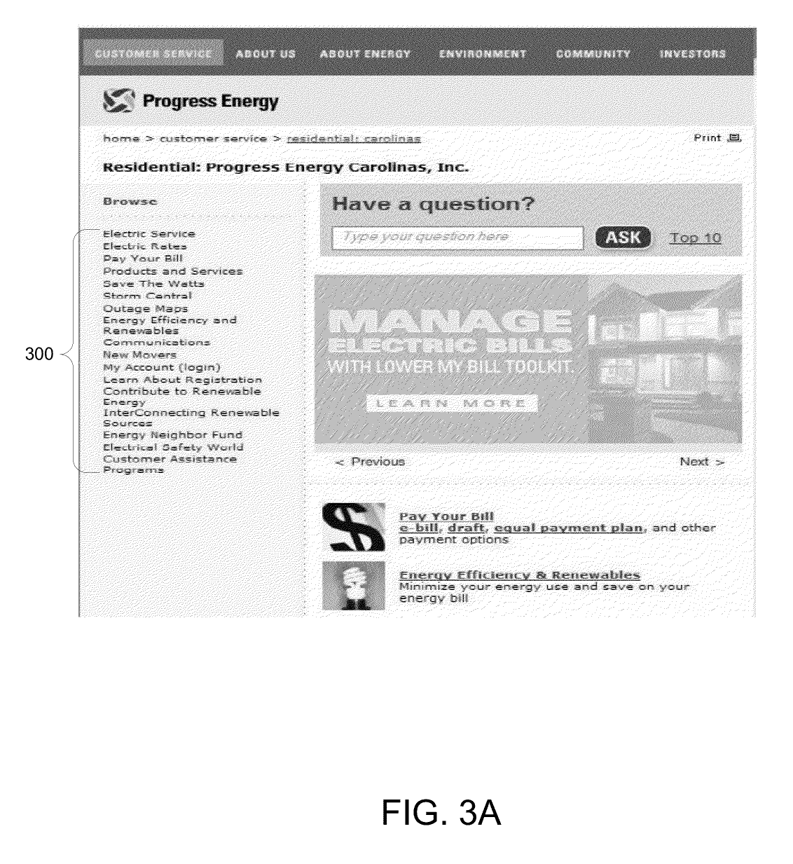

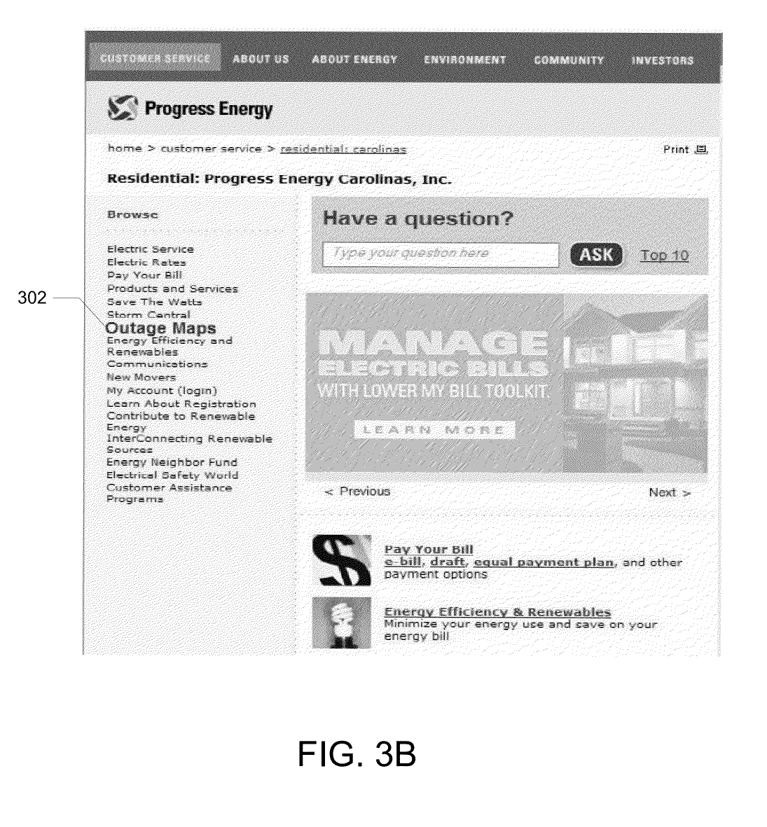

FIGS. 3A and 3B are diagrams illustrating an example web page showing how the exemplary embodiments may be used to increase viewability of page elements therein. FIG. 3A shows an example homepage 300 for Progress Energy. The homepage includes several page elements, including a navigation menu 302 listing links to other areas of Progress Energy's website.

When there is a power outage in Progress Energy's area, users may use the website to report the power outage. Assume that the typical user clicks on the link for “Storm Central” in order to find the page for reporting power outages. Assume further that the storm central web page is off-line for maintenance. Therefore, users must us an alternative route to report the power outage, which in this example, is to click the link for “Outage Maps”. As many people begin clicking the “Outage Maps” to report the outage, the analytics software 32 record statistics showing that the hits for “Outage Maps” has recently increased by a large percentage over the average hit rate for that link.

FIG. 3B shows that in response, the usage pattern engine 34 increases the size of the “Outage Maps” link 302 so that it is more easily noticed and found by other users attempting to report the power outage. The “Outage Maps” link could also be moved towards the top of the navigation menu to make it even more viewable and accessible.

A method and system for dynamically reorganizing page elements of a web application has been disclosed. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium that may include, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, partly on the user's computer and partly on a remote computer or entirely on the remote computer or server.

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A computer-implemented method for dynamically reorganizing page elements of a web application, comprising:
in response to a server presenting the web application, monitoring by analytics software a set of accesses from user computers to the page elements to detect trends in usage patterns;
visualizing the trends in the usage patterns by dynamically modifying a layout of the page elements based on the trends; and
outputting the modified layout of page elements for presentation to the user computers.

2. The method of claim 1 further comprising detecting trends in usage patterns for at least one of: all users of the web application, a subset of all the users of the web application, an individual user of the web application, users of the web application associated with a social network, and a monitored condition.

3. The method of claim 1 wherein the page elements are displayed by the web application in an information resource, wherein modifying a layout of the page elements further includes moving a position of at least one of the page elements towards a top of the information resource as the usage of the at least one page element increases.

4. The method of claim 3 wherein modifying a layout of the page elements further includes moving the position of the at least one of the page elements towards a bottom of the information resource as the usage of the at least one of the page elements decreases.

5. The method of claim 3 wherein modifying a layout of the page elements further includes adding or removing the at least one of the page elements to or from the information resource based on increased use or decreased use, respectively.

6. The method of claim 1 further comprising modifying a visual characteristic of at least one of the page elements by at least one of: changing a color of one of the page elements, and increasing or decreasing a size of the at least one of the page elements as usage of page the element increases or decreases, respectively.

7. The method of claim 1 further comprising providing user-configurable preferences to enable a user profile or a global profile, where the user profile configures a usage pattern engine to dynamically modify the page elements based on an individual user's usage patterns, and the global profile configures the usage pattern engine to dynamically modify the page elements based on all user's usage patterns.

8. An executable software product stored on a computer-readable medium containing program instructions for dynamically reorganizing page elements of a web application, the program instructions for:
in response to a server presenting the web application, monitoring by analytics software a set of accesses from user computers to the page elements to detect trends in usage patterns;
visualizing the trends in the usage patterns by dynamically modifying a layout of the page elements based on the trends; and
outputting the modified layout of page elements for presentation to the user computers.

9. The executable software product of claim 8 further comprising detecting trends in usage patterns for at least one of: all users of the web application, a subset of all the users of the web application, an individual user of the web application, users of the web application associated with a social network, and a monitored condition.

10. The executable software product of claim 8 wherein the page elements are displayed by the web application in an information resource, wherein modifying a layout of the page elements further includes moving a position of at least one of the page elements towards a top of the information resource as the usage of the at least one page element increases.

11. The executable software product of claim 10 wherein modifying a layout of the page elements further includes moving the position of the at least one of the page elements towards a bottom of the information resource as the usage of the at least one of the page elements decreases.

12. The executable software product of claim 10 wherein modifying a layout of the page elements further includes adding or removing the at least one of the page elements to or from the information resource based on increased use or decreased use, respectively.

13. The executable software product of claim 8 further comprising modifying a visual characteristic of at least one of the page elements by at least one of: changing a color of one of the page elements, and increasing or decreasing a size of the at least one of the page elements as usage of page the element increases or decreases, respectively.

14. The executable software product of claim 8 further comprising providing user-configurable preferences to enable a user profile or a global profile, where the user profile configures a usage pattern engine to dynamically modify the page elements based on an individual user's usage patterns, and the global profile configures the usage pattern engine to dynamically modify the page elements based on all user's usage patterns.

15. A server, comprising:
a memory;
a processor coupled to the memory; and
software components executed by the processor that are configured to:
in response to presentation of a web application comprising page elements, monitor a set of accesses from user computers to the page elements to detect trends in usage patterns;
visualize the trends in the usage patterns by dynamically modifying a layout of the page elements based on the trends; and
output the modified layout of page elements for presentation to the user computers.

16. The server of claim 15 wherein the software components are further configured to detect trends in usage patterns for at least one of: all users of the web application, a subset of all the users of the web application, an individual user of the web application, users of the web application associated with a social network, and a monitored condition.

17. The server of claim 15 wherein the page elements are displayed by the web application in an information resource, wherein modifying a layout of the page elements further includes moving a position of at least one of the page elements towards a top of the information resource as the usage of the at least one page element increases.

18. The server of claim 17 wherein modifying a layout of the page elements further includes moving the position of the at least one of the page elements towards a bottom of the information resource as the usage of the at least one of the page elements decreases.

19. The server of claim 17 wherein modifying a layout of the page elements further includes adding or removing the at least one of the page elements to or from the information resource based on increased use or decreased use, respectively.

20. The server of claim 15 wherein the software components are further configured to modify a visual characteristic of at least one of the page elements by at least one of: changing a color of one of the page elements, and increasing or decreasing a size of the at least one of the page elements as usage of page the element increases or decreases, respectively.

21. The server of claim 15 further comprising providing user-configurable preferences to enable a user profile or a global profile, where the user profile configures a usage pattern engine to dynamically modify the page elements based on an individual user's usage patterns, and the global profile configures the usage pattern engine to dynamically modify the page elements based on all user's usage patterns.
